(19) United States
(12) Patent Application Publication
(10) Pub. No.: US 2012/0159368 A1
(43) Pub. Date: Jun. 21, 2012

(54) SEARCH HISTORY NAVIGATION

(75) Inventors: Belmer Perella Garcia Negrillo, San Francisco, CA (US); Michael Ari Katz, Mountain View, CA (US); Roel Ramirez, Hayward, CA (US)

(73) Assignee: eBay Inc., San Jose, CA (US)

(21) Appl. No.: 12/972,363

(22) Filed: Dec. 17, 2010

(51) Int. Cl. G06F 3/048

(52) U.S. Cl. 715/771

(57) ABSTRACT

A server machine manages a user interface displayed at a client device. The user interface has a graphical layout that includes one or more search icons that respectively represent queries in a history of searches. In response to a cursor event corresponding to one of the search icons, the server machine presents a graphical window that shows information describing a previously executed query. In response to another cursor event corresponding to the search icon, the server machine causes the graphical layout to present search results returned by the previously executed query. Furthermore, in response to a request to delete a particular search icon from the graphical layout, the server machine deletes or ignores a search record corresponding to the particular search icon.

### TECHNICAL FIELD

The subject matter disclosed herein generally relates to data processing. Specifically, the present disclosure addresses systems and methods of facilitating search history navigation.

### BACKGROUND

A machine may be configured to facilitate searching by a user. For example, a general-purpose computer may be configured (e.g., by special-purpose software) as a special-purpose computer that functions as a search engine for searching a database. A user of a client device may submit a query to the search engine. In response, the search engine may identify search results within the database based on the submitted query and present the search results to the client device for viewing by the user. Viewing the presented search results, the user may operate the client device to select a particular search result from among the presented search results.

Where there are many search results to be presented, the search engine may present the search results only a portion at a time. For example, the search results may be subdivided into multiple pages and presented one page at a time. As another example, the search results may be presented on one single page that extends beyond a viewable screen area displayed by the client device. The client device may display only a portion of the search results at a time, and the user may operate the client device to adjust (e.g., move, scroll, zoom, or pan) the page displaying the search results in a manner that displays another portion of the search results in the viewable screen area.

### BRIEF DESCRIPTION OF THE DRAWINGS

Some embodiments are illustrated by way of example and not limitation in the figures of the accompanying drawings in which:

FIG. 1 is a diagram of a graphical layout presenting a first search icon, according to some example embodiments;

FIG. 2 is a diagram of the graphical layout presenting the first search icon and a second search icon, according to some example embodiments;

FIG. 3 is a diagram of the graphical layout presenting a graphical window that includes a portion of a first search record, according to some example embodiments;

FIG. 4 is a diagram of the graphical layout presenting a first set of search results returned by a first query, according to some example embodiments;

FIG. 5 is a diagram of the graphical layout presenting the second search icon without a search icon, according to some example embodiments;

FIG. 6 is a diagram of the graphical layout without two search icons, according to some example embodiments;

FIG. 7 is a network diagram illustrating a network environment suitable for search history navigation, according some example embodiments;

FIG. 8 is a block diagram illustrating components of a server machine suitable for search history navigation, according some example embodiments;

FIG. 9 is a block diagram of a database storing a first search record and a second search record, according to some example embodiments;

FIG. 10-11 are flowcharts illustrating a method of facilitating search history navigation, according to some example embodiments; and

FIG. 12 is a block diagram illustrating components of a machine, according to some example embodiments, able to read instructions from a machine-readable medium and perform any one or more of the methodologies discussed herein.

### DETAILED DESCRIPTION

Example methods and systems are directed to facilitating search history navigation. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A server machine is communicatively coupled to a client device of a user and presents a user interface to the user at the client device. The user interface has a graphical layout of one or more icons that respectively represent queries in a search history. The search history may correspond to the user, the client device, or both. The graphical layout of the user interface includes a first search icon and a second search icon. The first search icon represents a first query executed at a first time, and a second search icon represents a second query executed at a second time, which is after the first time. The graphical layout indicates that the first query is executed prior to the second query. This may have the effect of allowing the user to view the first and second query as a sequence (e.g., a chain) of searches.

In response to a cursor event corresponding to the first search icon (e.g., a mouse over event or a mouse click event), the server machine presents a graphical window that includes information describing the first query. For example, the graphical window may be presented in response to a mouse over event (e.g., a hover event) over the first search icon. The information may include one or more search criteria used in the first query, one or more search results returned by the first query, the quantity of the search results (e.g., a count of the search result), or any suitable combination thereof. This information may be stored in a first search record (e.g., within a database), and the graphical window may include a portion of the first search record. This may have the effect of allowing the user to view search criteria, search results, or the quantity of search results corresponding to the first query.

In response to a cursor event (e.g., a further cursor event) that corresponds to the first search icon, the server machine presents the search results returned by the first query (e.g., as a set of search results). For example, the search results may be presented in response to a mouse click event on the first search icon. This may have the effect of allowing a user to display a previously displayed set of search results obtained from a previously executed query. The user may navigate through the search history to revisit earlier search results, as if navigating back in time to an earlier query.

The server machine may support management of a search history (also called a “history of searches”) by the user. In response to a suitable cursor event, the server machine may delete a search record from the search history and update the graphical layout by removing a search icon corresponding to the deleted search record. The server machine may store the search history as corresponding to the user, in response to a request received from a client device of the user. In some example embodiments, the server machine may limit a search history to a maximum quantity of search records.

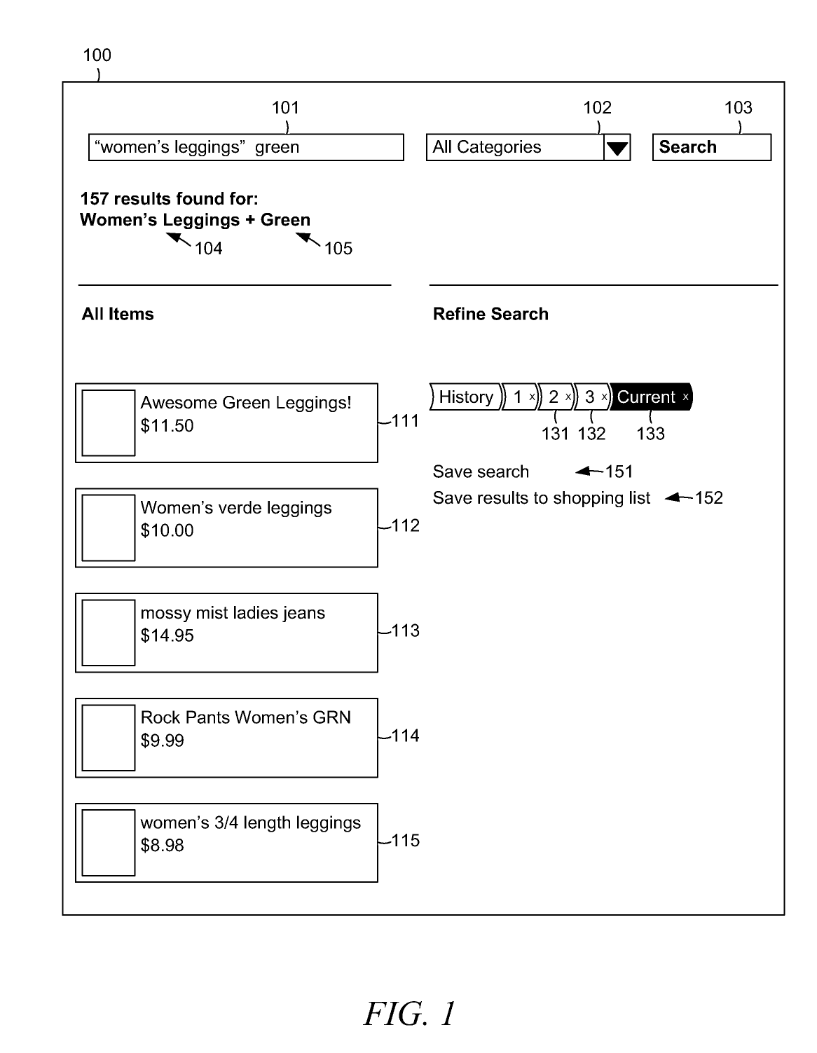

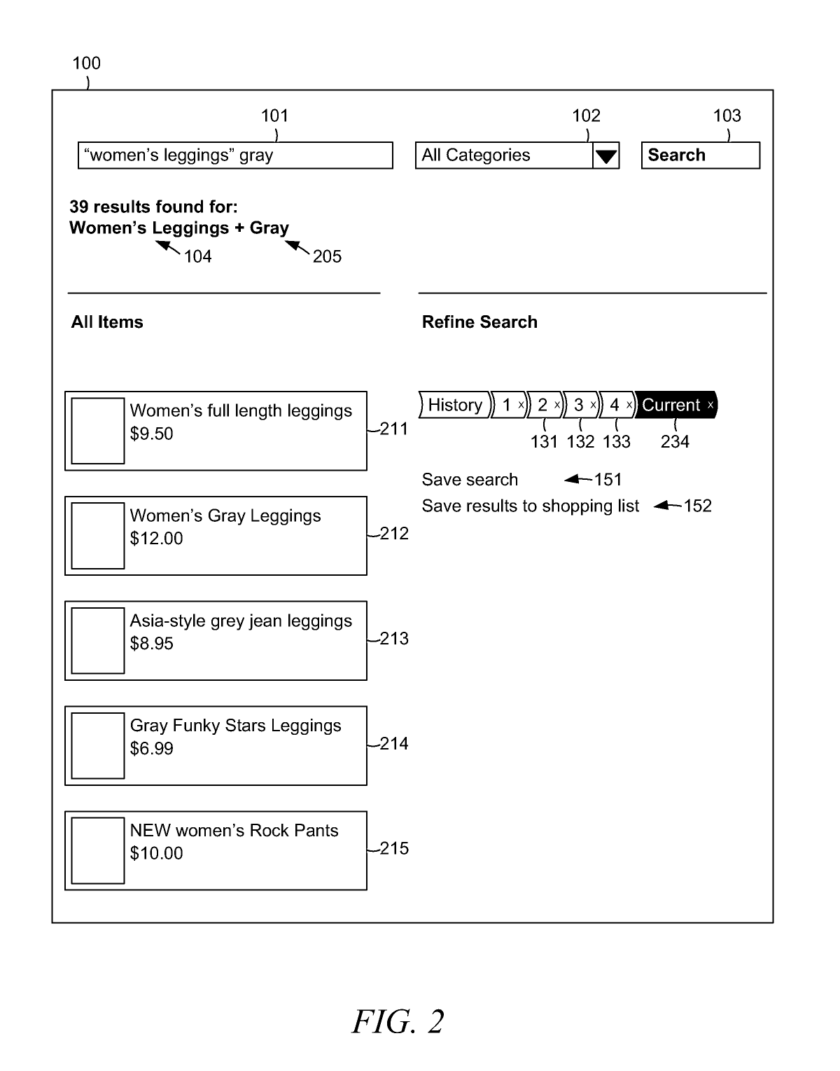

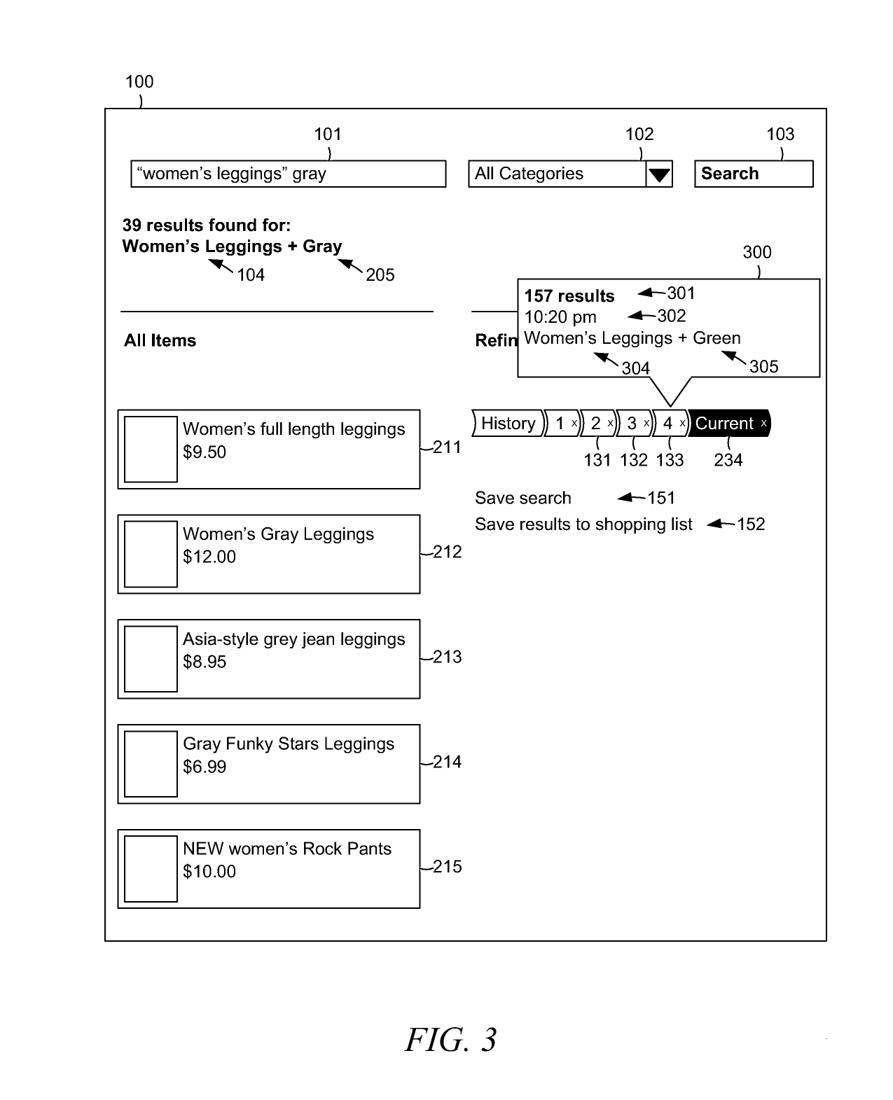

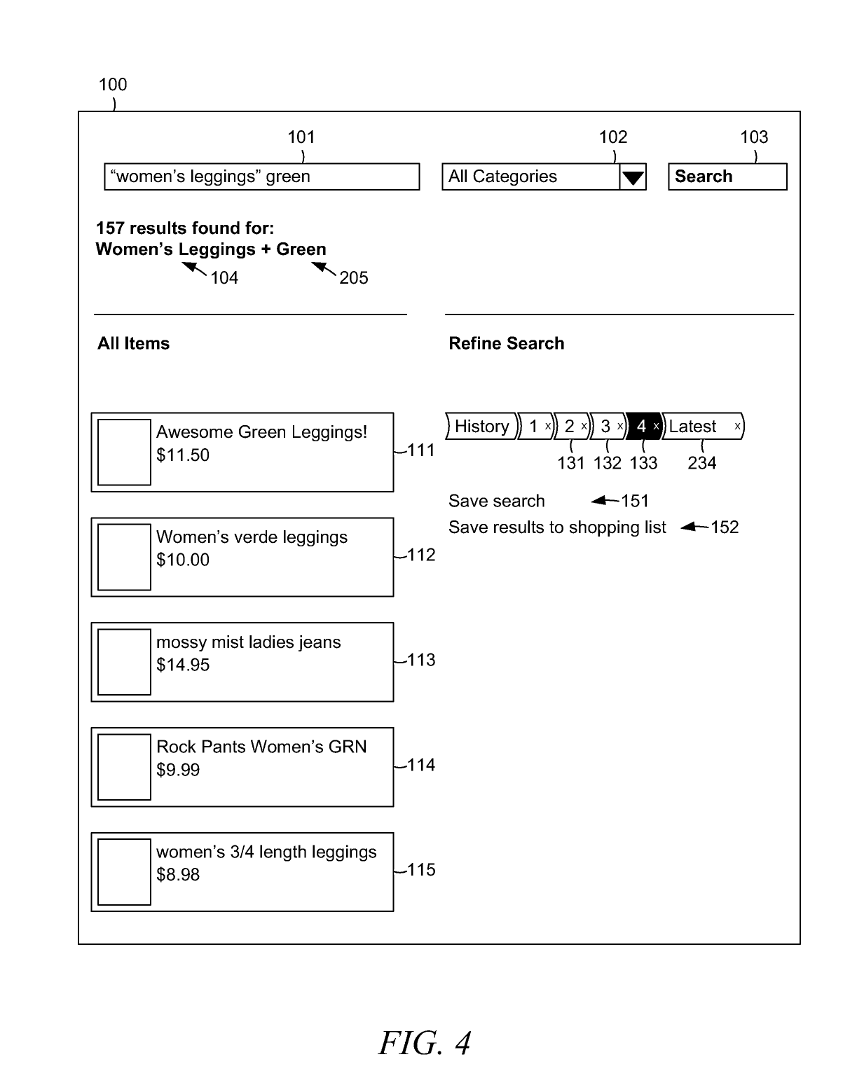

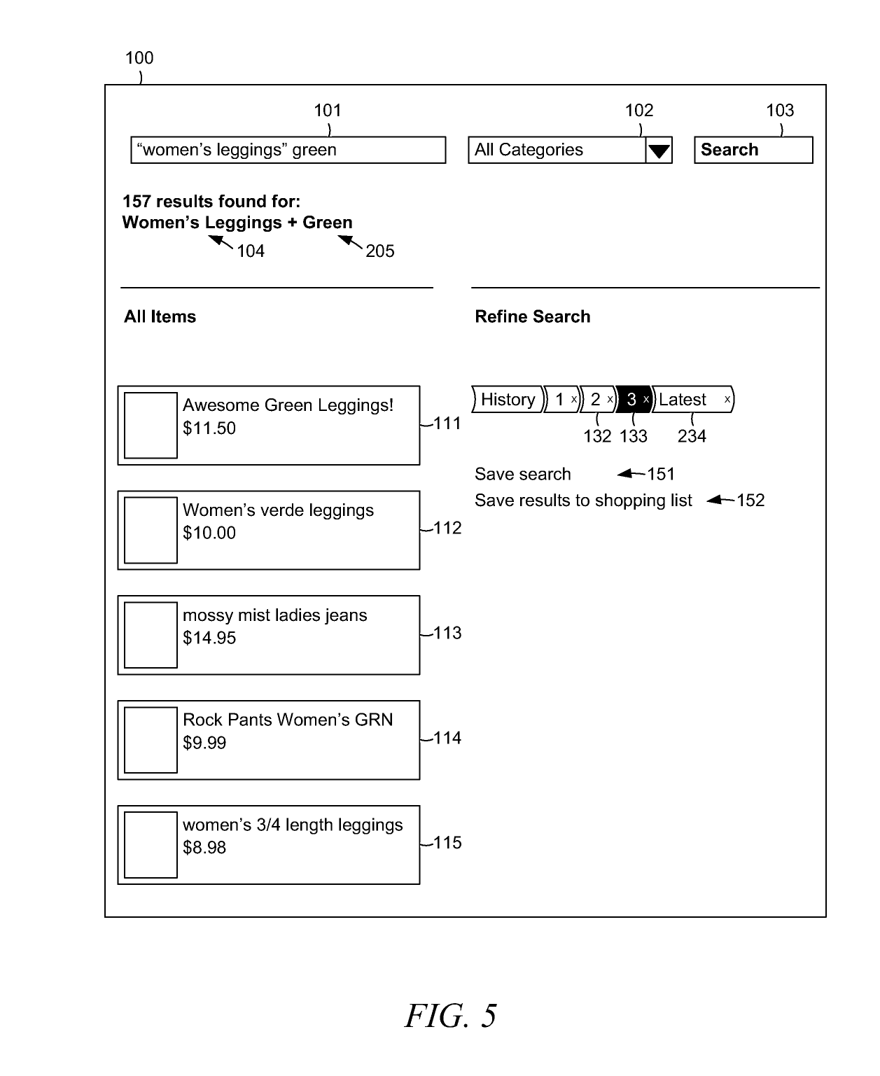

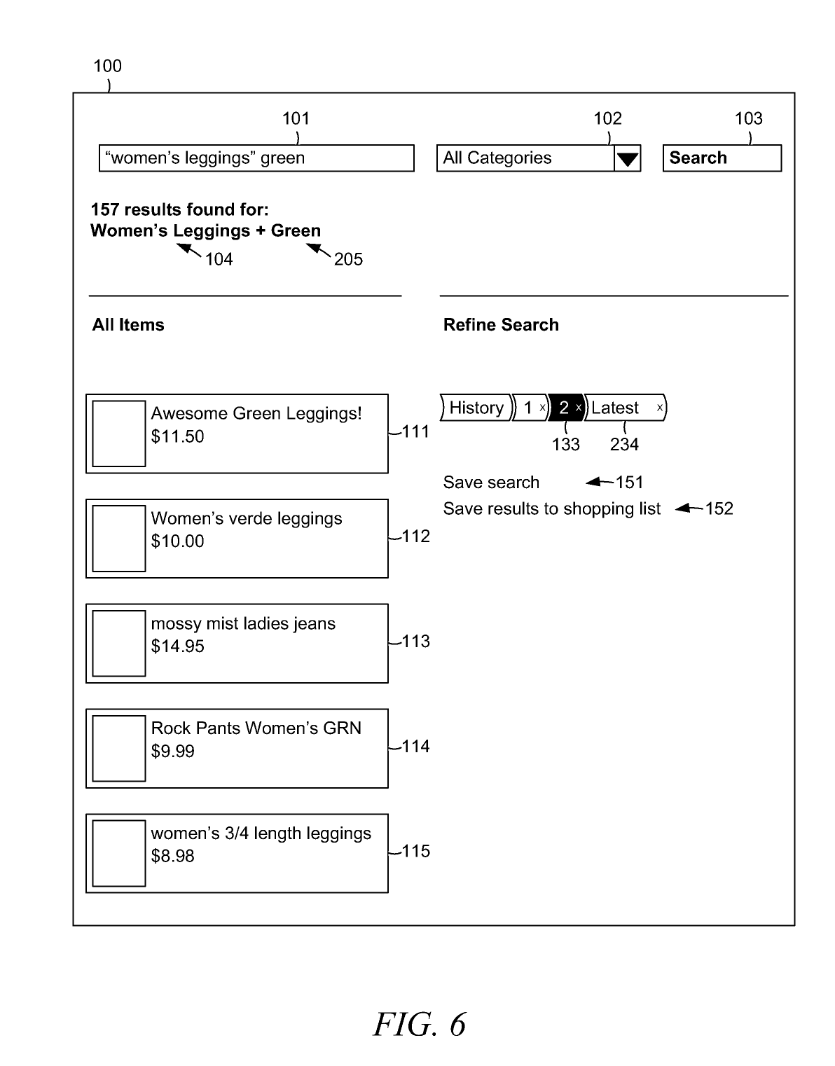

FIG. 1-2 illustrate two successive queries that each generate a set of search results. One query is executed first and results in one set of search results, and the other query is executed subsequently and generates another set of search results. FIG. 3-4 depict the user interface that enables the user to view information from the earlier query and initiate a display of search results from the earlier query. FIG. 5-6 each illustrate deletion of a search record from the search history, starting from the user interface as shown in FIG. 4.

FIG. 1 is a diagram of a graphical layout 100 presenting a first search icon 133, according to some example embodiments. The graphical layout 100 may form all or part of a user interface presented to the user by a server machine via a client device of the user. FIG. 1 shows the graphical layout 100 as it may appear after execution of a query for women's leggings that are green in color.

The graphical layout 100 includes a query field 101, a pull-down menu 102, and a search execution button 103. As shown, the query field 101 contains text defining two search criteria 104 and 105. The search criterion 104 is the phrase “women's leggings,” and the search criterion 105 is the word “green.” The pull-down menu 102 indicates that “All Categories” within a database are subject to querying upon operation of the search execution button 103. The search execution button 103 is operable to execute a query using information from the query field 101 and the pull-down menu 102. This query may be referred to as the “first query.”

FIG. 1 also shows the graphical layout 100 presenting (e.g., by inclusion) a set of search results 111-115 returned by the query based on the information from the query field 101 and the pull-down menu 102. As shown, the search criteria 104 and 105 are used in this query and hence correspond to the search results 111-115. In this example, the search results 111-115 constitute a portion of “157 results found for: Women's Leggings+Green.” Accordingly, the search results 111-115 may be referred to as a portion of a “first set” of search results returned by the first query, where the first query is for women's leggings that are green.

As shown in FIG. 1, the first search icon 133 and search icons 131 and 132 are arranged in the graphical layout 100. The search icon 131 is adjacent to the search icon 132, which is adjacent to the first search icon 133. The shape, arrangement, and text (e.g., sequential numerals) of the first search icon 133 and the search icons 131 and 132 indicate a history of searches previously executed (e.g., a search history). In particular, the first search icon 133 represents the first query, which is executed at a particular time (e.g., a first time).

As shown, the word “Current” appears in the first search icon 133 and indicates that the search results 111-115 presented in the graphical layout 100 are returned by the current query, which is executed using the search criteria 104 and 105. Moreover, the first search icon 133 may be highlighted (e.g., using color) as an indication that the first search icon 133 corresponds to the current query. The search icons 131 and 132 respectively represent queries executed prior to the current query. In the example shown, the query represented by the search icon 131 occurred prior to the query represented by the search icon 132, which occurred prior to the current query, which is represented by the first search icon 133.

The graphical layout 100 also includes a search storage link 151 and a results storage link 152. Operation of the search storage link 151 initiates a request to store (e.g., save) the history of searches in a database (e.g., for later retrieval). For example, the history of searches may be saved as a set of search records, where each of the search records in the set describes a query represented by a search icon (e.g., search icon 131). Operation of the results storage link 152 initiates a request to store the search results 111-115 of the current query in a database (e.g., for later retrieval). For example, the search results 111-115 may be saved as a set or a list of search results, where each member of the set or list describes a corresponding search result (e.g., search result 111). The set or list of search results may be stored as corresponding to a user. In some example embodiments, the list of search results may form all or part of a search record that corresponds to the current query, which is represented by the first search icon 133.

FIG. 2 is a diagram of the graphical layout 100 presenting the first search icon 133 and a second search icon 234, according to some example embodiments. FIG. 2 shows the graphical layout 100 as it may appear after execution of a query for women's leggings that are gray in color.

The graphical layout 100 includes the query field 101, which contains text defining two search criteria 104 and 205 used in a new query. As shown in FIG. 2, the search criterion 205 replaces the search criterion 105 shown in FIG. 1. The search criterion 104 remains the phrase “women's leggings,” and the search criterion 205 is the word “gray.” The pull-down menu 102 likewise indicates information used in the new query, which in the example shown coincides with corresponding information shown in FIG. 1. The search execution button 103 is operable to execute a query using information from the query field 101 and the pull-down menu 102. This query may be referred to as the “second query,” since it is subsequent to the first query.

FIG. 2 also shows the graphical layout 100 presenting (e.g., by inclusion) a set of search results 211-215 returned in response to the query based on information from the query field 101 and the pull-down menu 102. Specifically, the search criteria 104 and 205 are used in this query and hence correspond to the search results 211-215. In this example, the search results 211-215 constitute a portion of “39 results found for: Women's Leggings+Gray.” Accordingly, the search results 211-215 may be referred to as a portion of a “second set” of search results returned by the second query, where the second query is for women's leggings that are gray.

As shown in FIG. 2, a second search icon 234 appears in the graphical layout 100, arranged with the first search icon 133 and the search icons 131 and 132. The search icon 131 is adjacent to the search icon 132, which is adjacent to the first search icon 133, which in turn is adjacent to the second search icon 234. The shape, arrangement, and text (e.g., sequential numerals) of the second search icon 234, the first search icon 133, and the search icons 131 and 132 indicate the history of searches (e.g., the search history). Moreover, the second search icon 234 indicates that the history of searches is modified (e.g., extended) compared to its appearance in FIG. 1. In particular, the second search icon 234 represents the second query, which is executed at a time (e.g., a second time) subsequent to execution of the first query.

As shown, the word “Current” appears in the second search icon 234 and indicates that the search results 211-215 presented in the graphical layout 100 are returned by the current query, which is executed using the search criteria 104 and 205. Moreover, the second search icon 234 may be highlighted (e.g., using color) as indication that the second search icon 234 corresponds to the current query. The first search icon 133 represents the first query, as described with respect to FIG. 1. The search icons 131 and 132 continue to represent respective queries executed prior to the first query.

The search storage link 151, as shown in FIG. 2, is operable to initiate a request to store the history of searches, which now includes the second query represented by the second search icon 234. The results storage link 152, as shown in FIG. 2, is operable to initiate a request to store the search results 211-215 being presented in the graphical layout 100.

FIG. 3 is a diagram of the graphical layout 100 presenting a graphical window 300 that includes a portion of a first search record, according to some example embodiments. FIG. 3 shows the graphical layout 100 as it may appear after a cursor event (e.g., a mouse over event) corresponding to the first search icon 133 (e.g., a hover event over the first search icon 133). In some example embodiments, the cursor event causes (e.g., triggers or initiates) the presentation of the graphical window 300.

The graphical window 300 includes information regarding the query that is represented by the first search icon 133. This query may be referred to as the “first query.” This information may be stored as all or part of a search record (e.g., a first search record). As shown in FIG. 3, the graphical window 300 includes a number of search results 301 returned by the first query, a search time 302 of the first query, and search criteria 304 and 305. The shape and position of the graphical window 300 within the graphical layout 100 indicates that the graphical window 300 corresponds to the first search icon 133. As shown, the second search icon 234 is highlighted (e.g., using color) as an indication that the second query is the current query presented in the graphical layout 100.

The number of search results 301 may be referred to as a “first number” of search results resultant from the first query (e.g., 157 results). The search time 302 of the first query may be referred to as a “first time” at which the first query was executed (e.g., 10:20 pm). The search criteria 304 and 305 respectively indicate search criteria used in the first query, namely, the search criterion 104 (“women's leggings”) and the search criteria 105 (“green”). In some example embodiments, the search criterion 304 is the same as a search criterion 104, and the search criterion 305 is the same as the search criterion 105.

As shown in FIG. 3, the search criteria 104 and 205 and the search results 211-215 remain presented in the graphical layout 100. Accordingly, the graphical layout 100 with the graphical window 300 may have the effect of presenting information regarding the first query (e.g., 157 results for “women's leggings” and “green”) for a comparison with other information currently presented in the graphical layout 100 (e.g., 39 results for “women's leggings” and “gray”).

FIG. 4 is a diagram of the graphical layout 100 presenting the first set of search results 111-115 returned by the first query, according to some example embodiments. FIG. 4 shows the graphical layout 100 as it may appear after a cursor event (e.g., a mouse click event) corresponding to the first search icon 133, which causes a redisplay of the first set of search results 111-115.

The graphical layout 100 includes the query field 101, containing text defining two search criteria 104 and 105, which were used in the first query. Similarly, the pull-down menu 102 may reflect information used in the first query. The graphical layout 100 also includes the search criterion 104 and 105, as well as the search results 111-115.

The color, shape, text (e.g., “4”), and relative position of the first search icon 133 with respect to the history of searches indicates that the graphical layout 100 is presenting information and search results from the first query. For example, the first search icon 133 may have a highlighted color, as shown in FIG. 4. Moreover, the color, shape, text (e.g., “Latest”), and position of the second search icon 234 with respect to the history of searches indicates that the second query is the most recent query.

It will be appreciated that, in FIG. 4, the search icon 131 may include a deletion button (shown with an “x” symbol). In some example embodiments, the deletion button may appear only after a cursor event (e.g., a mouse over event) corresponding to the search icon 131. Operation of the deletion button initiates a request to delete the search icon 131 from the history of searches, delete the search record corresponding to the search icon 131 from a database, or any suitable combination thereof.

FIG. 5 is a diagram of the graphical layout 100 presenting the history of searches without the search icon 131, according to some example embodiments. FIG. 5 shows the graphical layout 100 as it may appear after operation of the deletion button in the search icon 131, as discussed with respect to FIG. 4, in a situation where the query corresponding to the search icon 132 is independent of (e.g., has no dependencies on) the query corresponding to the search icon 131.

As shown in FIG. 5, in response to operation of the deletion button of the search icon 131, the graphical layout 100 presents the history of searches as including the search icon 132, the first search icon 133, and the second search icon 234. The search icon 131 is absent from the graphical layout 100. The shape, arrangement, and text of the search icon 132, the first search icon 133, and the second search icon 234 indicate that their respective positions within the history of searches remain unchanged, despite the disappearance of the search icon 131. As shown, the search icon 132 and the first search icon 133 have been renumbered to reflect the absence of the search icon 131.

The first search icon 133 remains colored with the highlighted color as an indication that the graphical layout 100 is presenting information and search results from the first query, namely, the search results 111-115. Moreover, the color, shape, text, and position of the second search icon 234 continue to indicate that the second query is the most recent query (e.g., “Latest”).

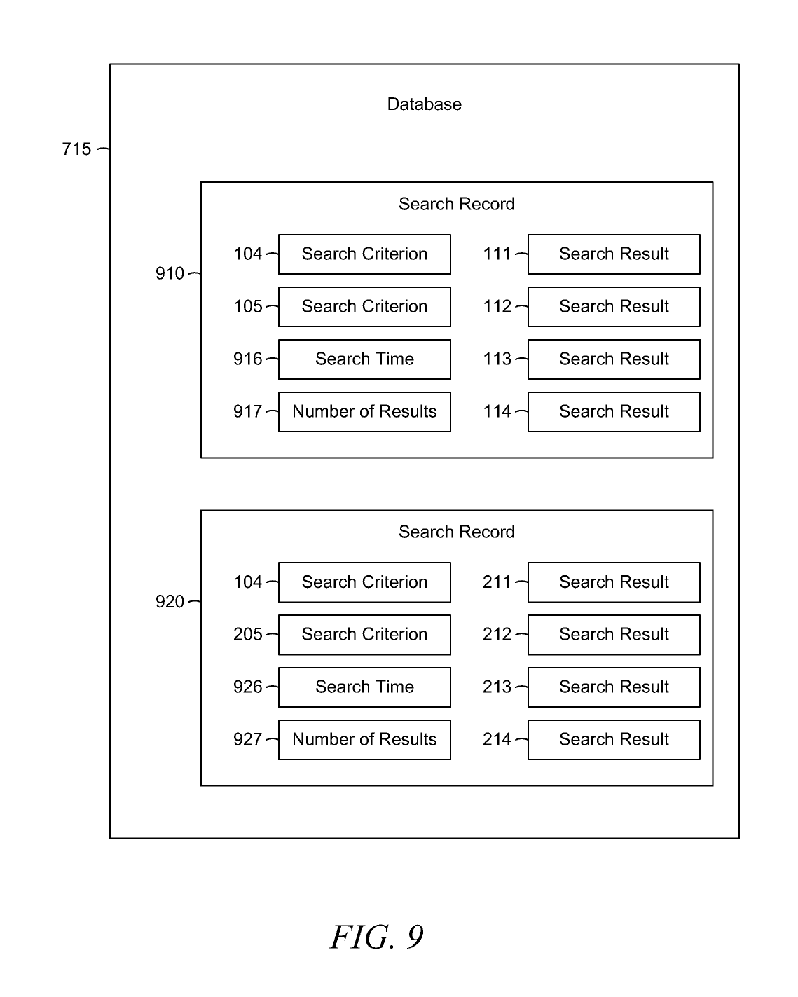

FIG. 6 is a diagram of the graphical layout 100 without the search icon 131 and without the search icon 132, according to some example embodiments. FIG. 6 shows the graphical layout 100 as it may appear after operation of the deletion button in the search icon 131, as discussed above with respect to FIG. 4, in an alternate situation where the query corresponding to the search icon 132 is dependent on (e.g., has dependencies upon) the query corresponding to the search icon 131. Dependencies between queries are discussed in greater detail below with respect to FIG. 9. In some example embodiments, operation of the deletion button causes a confirmation dialog box to appear in the graphical layout 100, and upon operation of a confirmation button within the confirmation dialog box, the graphical layout 100 takes the appearance shown in FIG. 6.

As shown in FIG. 6, in response to operation of the deletion button of the search icon 131, the graphical window 100 presents the history of searches as including the first search icon 133 and a second search icon 234. The search icons 131 and 132 are absent from the graphical layout 100. The shape, arrangement, and text of the first search icon 133 and a second search icon 234 indicate that their respective positions within the history of searches remain unchanged, despite the disappearance of the search icons 131 and 132. As shown, the first search icon 133 has been renumbered to reflect the absence of the search icons 131 and 132.

The first search icon 133 remains colored with a highlighted color as an indication that the graphical layout 100 is presenting information and search results from the first query, namely, the search result 111-115. Moreover, the color, shape, text, and position of the second search icon 234 continue to indicate that the second query is the most recent query (e.g., “Latest”).

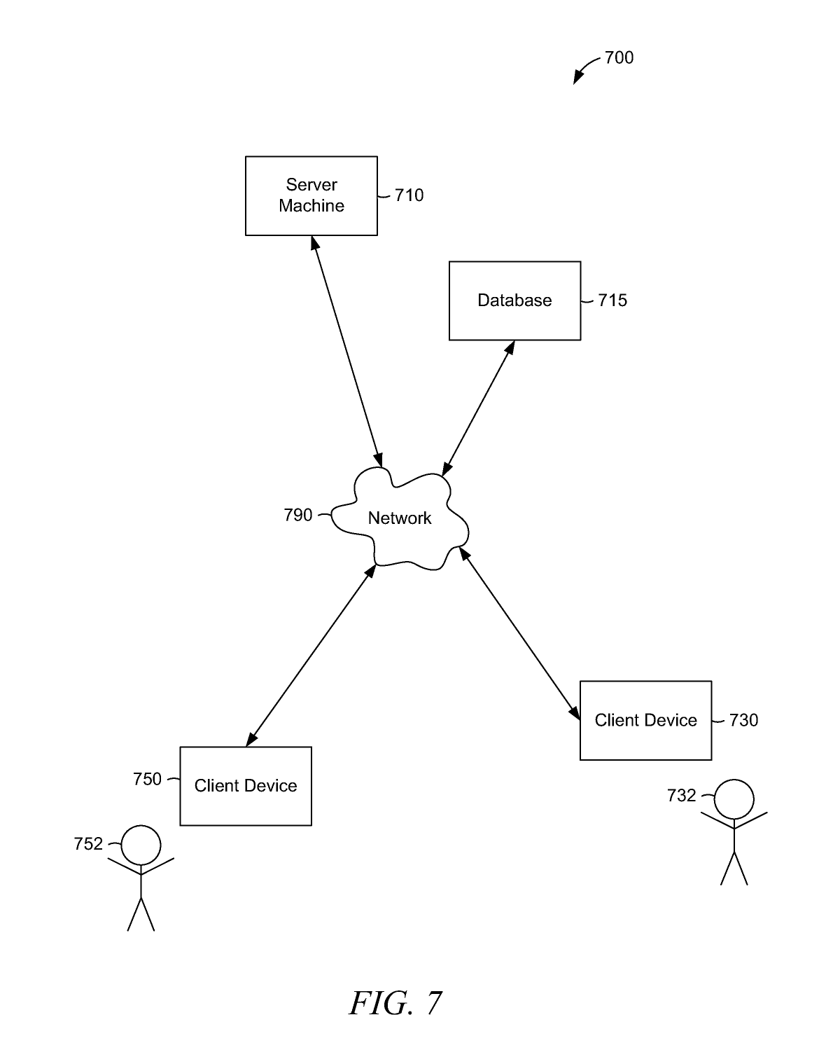

FIG. 7 is a network diagram illustrating a network environment 700 suitable for search history navigation, according some example embodiments. The network environment 700 includes a server machine 710, a database 715, and client devices 730 and 750, all communicatively coupled to each other via a network 790. The client devices 730 and 750 respectfully correspond to users 732 and 752.

The server machine 710 provides network-based services to one or more client devices (e.g., client device 730) and may form all or part of a web server, a network-based system (e.g., commerce system, publication system, listing system, merchandising system, or transaction system), a database server, or any suitable combination thereof. For example, the server machine 710 may function as a search engine, a shopping server, an electronic storefront, an online auction website, a classified ad server, or any suitable combination thereof. The database 715 stores data pertinent to the server machine 710 (e.g., search records respectively corresponding to queries represented in one or more histories of searches).

One or both of the users 732 and 752 may be a human user (e.g., a person interacting with a client device), a machine user (e.g., a software-configured device programmed to interact with a client device), or any suitable combination thereof. The user 732 is not part of the network environment 700, but is associated with the client device 730 and may be a user of the client device 730. For example, the client device 730 may be a deskside computer belonging to the user 732. Similarly, the user 752 is not part of the network environment 700, but is associated with the client device 750. As an example, the client device 750 may be a tablet computer belonging to the user 752.

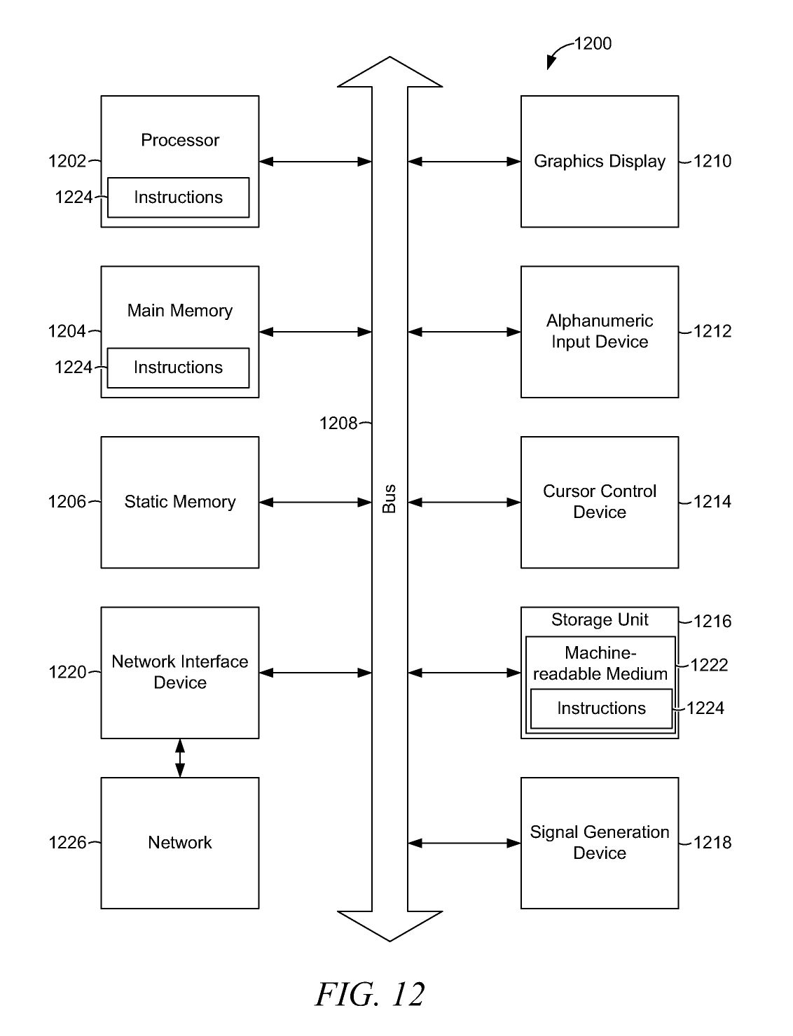

Any of the machines, databases, or devices shown in FIG. 7 may be implemented in a general-purpose computer modified (e.g., configured or programmed) by software to be a special-purpose computer to perform the functions described herein for that machine. For example, a computer system able to implement any one or more of the methodologies described herein is discussed below with respect to FIG. 12. As used herein, a “database” is a data storage resource and may store data structured as a text file, a table, a spreadsheet, a relational database, a triple store, or any suitable combination thereof. Moreover, any two or more of the machines illustrated in FIG. 7 may be combined into a single machine, and the functions described herein for any single machine may be subdivided among multiple machines.

The network 790 may be any network that enables communication between machines (e.g., server machine 710 and client device 730). Accordingly, the network 790 may be a wired network, a wireless network, or any suitable combination thereof. The network 790 may include one or more portions that constitute a private network, a public network (e.g., the Internet), or any suitable combination thereof.

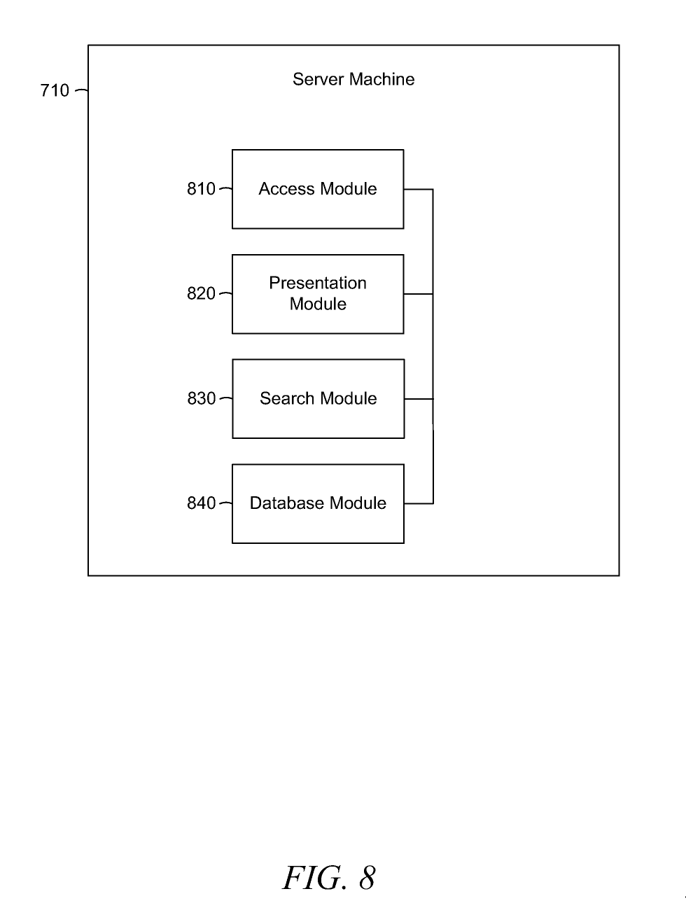

FIG. 8 is a block diagram illustrating components of the server machine 710, according some example embodiments. The server machine 710 includes an access module 810, a presentation module 820, a search module 830, and a database module 840, all configured to communicate with each other (e.g., via a bus, a shared memory, or a switch). Any one or more of these modules may be implemented in hardware or a combination of hardware and software (e.g., as a module executed by a processor of a machine). Moreover, any two or more of these modules may be combined into a single module, and, alternatively, the functions described herein for a single module may be subdivided among multiple modules.

The access module 810 is configured to access one or more search records (e.g., stored in the database 715). As used herein, a “search record” is a data structure that stores information descriptive of a query (e.g., the first query or the second query). For example, a search record may include a time of execution of the query, one or more search criteria used in the query, one or more search results returned in response to the query, a number that quantifies the search results returned in response to the query, or any suitable combination thereof.

The access module 810 is also configured to access (e.g., receive) user-generated inputs that correspond to the graphical layout 100. Examples of such user-generated inputs include cursor events, requests for action, submissions of information, or any suitable combination thereof. For example, the access module 810 may receive one or more cursor events (e.g., mouse over events or mouse click events). A cursor event may be generated by the user 732 using the client device 730 and sent via the network 790 to the server machine 710, wherein the access module 810 may receive the cursor event.

As another example, the access module 810 may access (e.g., receive) a request initiated by operation of a link (e.g., search storage link 151) appearing in the graphical layout 100. The access module 810 may provide the request or notification of the request to the presentation module 820 for execution of an action based on (e.g., in response to) the request.

Similarly, the access module 810 may access information submitted for use in a query (e.g., search criteria 104 and 105, plus information appearing in the pull-down menu 102). Such information may be provided by the access module 810 to the search module 830 for execution of the query and retrieval of search results returned by the query.

The presentation module 820 is configured to present information using all or part of one or more user interfaces. As noted above, the graphical window 100 may form all or part of a user interface. Accordingly, the presentation module 820 manages the graphical window 100 and may generate, communicate, modify, or refresh the graphical window 100 for display at a client device (e.g., client device 730). The presentation module 820 may be implemented by a processor of a machine.

In particular, the presentation module 820 is configured to present the first search icon 133 and the second search icon 234 within the graphical layout 100. The presentation module 820 may also present any one or more objects appearing in FIG. 1-6, including the search icons 131 and 132 and the graphical window 300. The shape, color, text of any one or more of these objects may be determined or modified by the presentation module 820 in the course of managing the graphical window 100.

The search module 830 is configured to execute one or more queries (e.g., one or more queries of the database 715) and obtain one or more search results returned by the one or more queries. In some example embodiments, the search module 830 includes a search engine configured to query the database 715. In alternative example embodiments, the search module 830 communicates with a separate search engine to submit queries and obtain search results returned by those queries.

The search module 830 is also configured to initiate storage of one or more search records (e.g., in the database 715). For example, when a query (e.g., the first query) is executed, the search module 830 may generate a search record that corresponds to the executed query. The search module 830 may include within the search record, information descriptive of the query (e.g., a time of execution, one or more search criteria, one or more search results, or a number that quantifies the search results). In some example embodiments, the search module 830 provides the generated search record, or a reference thereto, to the access module 810.

The database module 840 is configured to store information in the database 715. For example, the database module 840 may store one or more search records in the database 715 (e.g., as generated by the search module 830). As another example, the database module 840 may store a history of searches in the database 715 (e.g., by storing a set of search records corresponding to queries included in the history of searches). Storage of the history of searches may be performed in response to a request (e.g., received by the access module 710 from the client device 730). As a further example, the database module 840 may store search results (e.g., as a set or a list), and the search results may be stored as corresponding to a user (e.g., user 732). Storage of the search results may be performed in response to a request.

The database module 840 is also configured to manage the information stored in the database 715. For example, the database module 840 may determine that one particular search record depends on another search record (e.g., based on the particular search record being a modification or refinement of the other search record). The database module 840 may modify the database 715 by deleting one or more search records in response to a request (e.g., received by the access module 710 from the client device 730). Deletion of a search record may be based on a dependency between or among search records, based on the request, or both.

FIG. 9 is a block diagram of the database 715 storing a first search record 910 and a second search record 920, according to some example embodiments. The database 715 may store any number of search records. The first search record 910 stores information that describes the first query, which is represented in FIG. 1-6 by the first search icon 133. The second search record 920 stores information that describes the second query, which is represented in FIG. 2-6 by the second search icon 234.

The first search record 910 includes the search criterion 104 (“women's leggings”) and the search criterion 105 (“green”), which were used in executing the first query. The first search record 910 also includes a time of execution 916 of the first query, which may be referred to as a “first time.” As shown, the time of execution 916 is labeled “search time.” The first search record 910 further includes a number of results 917 (e.g., “157”) returned based on (e.g., in response to) the first query, which quantifies the search results returned based on the first query and which may be referred to as a “first number.” The first search record 910 is shown as additionally including the search results 111-114. Additional search results (e.g., search result 115) may be included in the first search record 910 and may be displayed or not displayed. Accordingly, the first search record 910 may be treated as a record of the first query, indicating what was submitted in the first query and what was returned based on the first query.

The second search record 920 includes the search criterion 104 (“women's leggings”) and the search criterion 205 (“gray”), which were used in executing the second query. The second search record 920 also includes a time of execution 926 of the second query, which may be referred to as a “second time.” As shown, the time of execution 926 is labeled “search time.” The second search record 920 further includes a number of results 927 (e.g., “39”) returned based on (e.g., in response to) the second query, which quantifies the search results returned based on the second query and which may be referred to as a “second number.” The second search record 920 is shown as additionally including the search results 211-214. Additional search results (e.g., search result 215) may be included in the second search record 920 and may be displayed or not displayed. Accordingly, the second search record 920 may be treated as a record of the second query, indicating what was submitted in the second query and what was returned based on the second query.

Although FIG. 9 depicts the first search record 910 and the second search record 920 as storing various information by inclusion, in certain example embodiments, information may be stored by reference (e.g., a pointer or an address) that indicates a location (e.g., elsewhere within the database 715) where the information may be accessed. For example, the second search record 920 may include its copy of the search criterion 104 by referencing the search criterion 104 as included in the first search record 910. This may have the effect of creating a dependency between the first search record 910 and the second search record 920, where the second search record 920 depends on the first search record 910. Similarly, search records corresponding to the search icons 131 and 132 may have a dependency relationship, where the search record corresponding to the search icon 132 is dependent on the search record corresponding to the search icon 131.

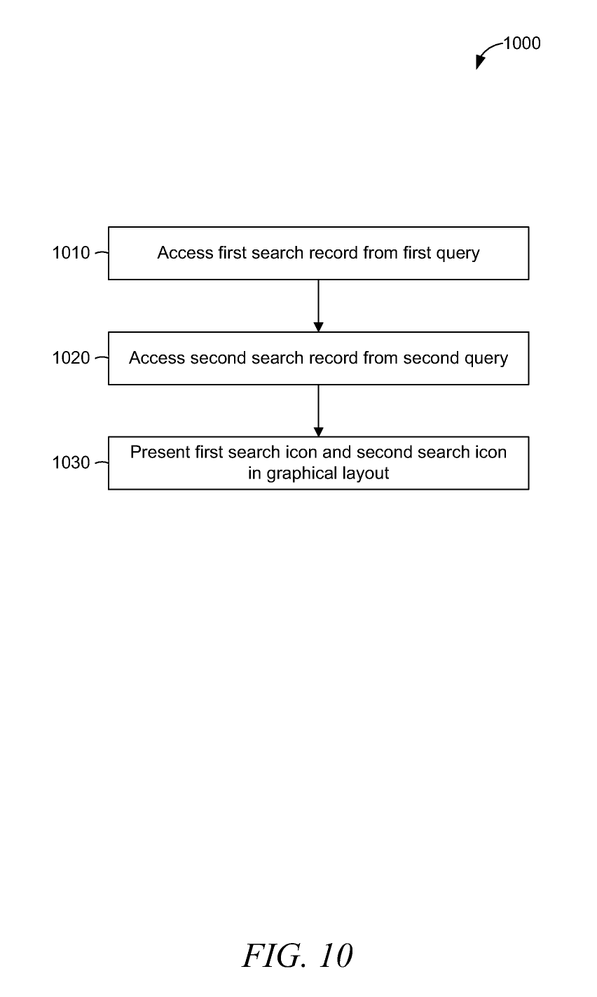

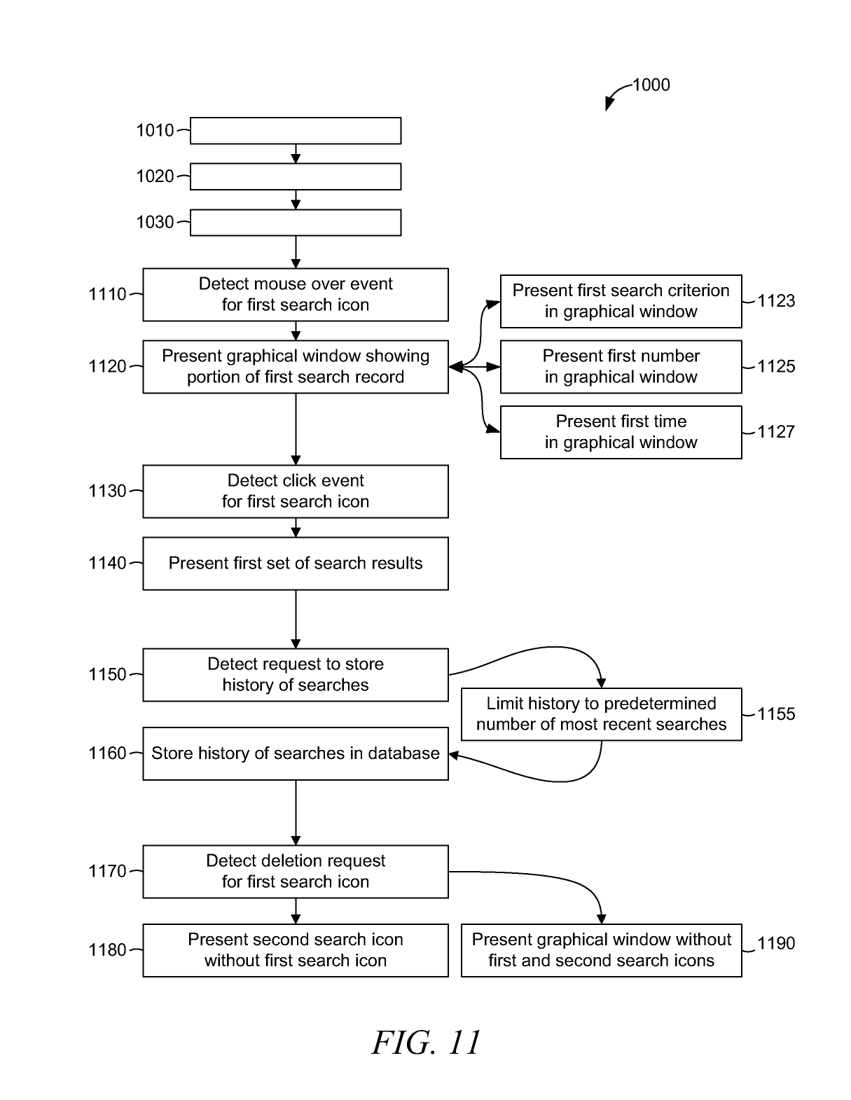

FIG. 10-11 are flowcharts illustrating a method 1000 of facilitating search history navigation, according to some example embodiments. Operations in the method 1000 may be performed by the server machine 710, using modules described above with respect to FIG. 8. In some example embodiments, execution of the method 1000 may be caused (e.g., trigger initiator) by a request received by the server machine 710 from the client device 730. For example, the request may be a submission of a search query (e.g., as indicated by a click on the search execution button 103).

As shown in FIG. 10, the method 1000 includes operations 1010, 1020, and 1030. In operation 1010, the access module 810 accesses the first search record 910 from the database 715. The first search record 910 indicates (e.g., by inclusion or by reference) the search criterion 105, which was used in the first query and may be referred to as a “first search criterion.” The first search record 910 also indicates the number of results 917 (e.g., a “first number”) that quantifies a set (e.g., a “first set”) of search results returned by the first query.

In operation 1020, the access module 810 accesses the second search record 920 from the database 715. The second search record 920 indicates (e.g., by inclusion or by reference) the search criterion 205, which was used in the second query and may be referred to as a “second search criterion.” The second search record 920 also indicates the number of results 927 (e.g., a “second number”) that quantifies a set (e.g., a “second set”) of search results returned by the second query.

In operation 1030, the presentation module 820 presents the first search icon 133 and the second search icon 234 within the graphical layout 100. As noted above, the graphical layout 100 indicates that the first query is executed prior to the second query. The presentation module 820 may perform operation 1030 based on the time of execution 916 and the time of execution 926, as accessed from the first search record 910 and the second search record 920. As noted above, the first search icon 133 represents the first query, and the second search icon 234 represents the second query. Accordingly, the graphical layout 100 may take the appearance shown in FIG. 2.

As shown in FIG. 11, the method 1000 may include operations 1110-1170, as well as operations 1010, 1020, and 1030 as discussed above with respect to FIG. 10. In operation 1110, the access module 810 accesses (e.g., receives or detects) a cursor event (e.g., a mouse over event) corresponding to the first search icon 133. For example, the access module 810 may detect that a cursor is hovering over the first search icon 133 within the graphical layout 100.

In operation 1120, the presentation module 820 presents the graphical window 300 within the graphical layout 100. The graphical window 300 includes at least a portion of the first search record 910. Operation 1120 may be performed in response to the cursor event accessed by the access module 810 in operation 1110. Accordingly, the graphical layout 100 may take the appearance shown in FIG. 3. As shown in FIG. 11, operation 1120 may include operations 1123, 1125, and 1127.

In operation 1123, the presentation module 820 presents the search criterion 105 as the search criterion 305 within the graphical window 300. In some example embodiments, the search criterion 305 is the same as the search criterion 105 (e.g., “green”). In alternative example embodiments, the search criterion 305 is generated by the presentation module 820 based on the search criterion 105 (e.g., as an abbreviated or reformatted version of the search criterion 105).

In operation 1125, the presentation module 820 presents the number of results 917 (e.g., the “first number”) as the number of search results 301 within the graphical window 300. In some example embodiments, the number of search results 301 is the same as the number of results 917 (e.g, “157”). In alternative example embodiments, the number of search results 301 is generated by the presentation module 820 based on the number of results 917 (e.g., as approximated or reformatted version of the number of results 917).

In operation 1127, the presentation module 820 presents the time of execution 916 (e.g., the “first time”) as the search time 302 within the graphical window 300. In some example embodiments, the search time 302 may be the same as the time of execution 916 (e.g., “10:20 pm”). In alternative example embodiments, the search time 302 may be generated by the presentation module 820 based on the time of execution 916 (e.g., as an approximated or reformatted version of the time of execution 916).

In operation 1130, the access module 810 accesses (e.g., receives or detects) another cursor event (e.g., a mouse click event) corresponding to the first search icon 133. For example, the access module 810 may detect a mouse click has occurred on the first search icon 133 within the graphical layout 100.

In operation 1140, the presentation module 820 presents the search results 111-115 as a set of search results (e.g., a “first set”) returned by the first query. Operation 1140 may be executed in response to the cursor event accessed by the access module 810 in operation 1130. Accordingly, the graphical layout 100 may take the appearance shown in FIG. 4.

According to alternative example embodiments, operations 1130 and 1140 may be performed with respect to the second search icon 234, instead of the first search icon 133. For example, the cursor event may correspond to the second search icon 234, and the search results 211-215 may be presented by the presentation module 820 as a set of search results (e.g., a “second set”) returned by the second query. The presenting of the search results 211-215 may be in response to a cursor event. Accordingly, the graphical layout 100 may retake the appearance shown in FIG. 2.

In operation 1150, the access module 810 accesses (e.g., receives or detects) a request to store the history of searches, as represented in the graphical layout 100. The request may be initiated by operation of the search storage link 151 within the graphical layout 100. History of searches may include the first search record 910 and the second search record 920.

In operation 1155, the database module 840 limits the history of searches to a predetermined number of queries (e.g., searches). For example, the history of searches may be limited to the most recent eight (8) queries. The database module 840 may perform operation 1155 based on a maximum quantity of search records, or the maximum quantity is represented by the predetermined number of queries. For example, if the maximum quantity of search records is eight (8), and the history of searches is represented by ten (10) search records, the database module 840 may truncate the history of searches by removing or ignoring the two (2) oldest search records. Hence, operation 1155 may be based on one or more times of execution (e.g., time of execution 916) within one or more search records (e.g., the first search record 910).

In operation 1160, the database module 840 stores the history of searches in the database 715. The database module 840 may store the history of searches as corresponding to the user 732, and the storage of the history of searches may be in response to the request accessed by the access module 810 in operation 1150.

In operation 1170, the access module 810 accesses (e.g., receives or detects) a request for deletion of the first search icon 133 from the graphical layout 100. In some example embodiments, such a request is treated as a request to delete the first search record 910 from the database 715. In alternative example embodiments, such a request is treated as a request to ignore the first search record 910 when presenting the history of searches in the graphical layout.

According to various example embodiments, in operation 1180, the database module 840 determines that the second search record 920 is not dependent on the first search record 910. This determination may be based on an absence of search criteria used in the first query (e.g., search criterion 105 (“green”)) from the second search record 920. In certain example embodiments, this determination may be based on an absence of a reference (e.g., a pointer or an address) to the first search record 910 within the second search record 920. Based on this determination, the presentation module 820 presents the second search icon 234 within the graphical layout 100 without the first search icon 133, in response to the request accessed by the access module 810 in operation 1170.

According to other example embodiments, in operation 1190, the database module 840 determines that the second search record 920 is dependent on the first search record 910. This determination may be based on a presence of one or more search criteria used in the first query (e.g., the search criterion 104 (“women's leggings”) within the second search record 920. In certain example embodiments, this determination may be based on a presence of a reference (e.g., a pointer or an address) to the first search record 910 within the second search record 920. Based on this determination, the presentation module 820 presents the graphical layout without the first search icon 133 and without the second search icon 234, in response to the request accessed by the access module 810 in operation 1170.

According to various example embodiments, one or more of the methodologies described herein may facilitate search history navigation. In particular, one or more of the methodologies described herein may constitute all or part of a business method (e.g., business method implemented by a machine) that enables one or more users of a network-based system to view one or more search criteria or one or more search results from a previously executed query. Accordingly, one or more the methodologies described herein may have the effect of allowing a user to navigate through his search history to revisit earlier search results, as if navigating back in time to an earlier query.

As a result, one or more of the methodologies described herein may obviate a need for certain efforts or resources that otherwise would be involved in research, decision-making, online shopping, or both. Efforts expended by a user in identifying a product for purchase may be reduced by one or more of the methodologies described herein. Computing resources used by one or more machines, databases, or devices (e.g., within the network environment 700) may similarly be reduced. Examples of such computing resources include processor cycles, network traffic, memory usage, data storage capacity, power consumption, and cooling capacity.

FIG. 12 illustrates components of a machine 1200, according to some example embodiments, that is able to read instructions from a machine-readable medium (e.g., a machine-readable storage medium) and perform any one or more of the methodologies discussed herein. Specifically, FIG. 12 shows a diagrammatic representation of the machine 1200 in the example form of a computer system and within which instructions 1224 (e.g., software) for causing the machine 1200 to perform any one or more of the methodologies discussed herein may be executed. In alternative embodiments, the machine 1200 operates as a standalone device or may be connected (e.g., networked) to other machines. In a networked deployment, the machine 1200 may operate in the capacity of a server machine or a client machine in a server-client network environment, or as a peer machine in a peer-to-peer (or distributed) network environment. The machine 1200 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1224 (sequentially or otherwise) that specify actions to be taken by that machine. Further, while only a single machine is illustrated, the term “machine” shall also be taken to include a collection of machines that individually or jointly execute the instructions 1224 to perform any one or more of the methodologies discussed herein.

The machine 1200 includes a processor 1202 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1204, and a static memory 1206, which are configured to communicate with each other via a bus 1208. The machine 1200 may further include a graphics display 1210 (e.g., a plasma display panel (PDP), a liquid crystal display (LCD), a projector, or a cathode ray tube (CRT)). The machine 1200 may also include an alphanumeric input device 1212 (e.g., a keyboard), a cursor control device 1214 (e.g., a mouse, a touchpad, a trackball, a joystick, a motion sensor, or other pointing instrument), a storage unit 1216, a signal generation device 1218 (e.g., a speaker), and a network interface device 1220.

The storage unit 1216 includes a machine-readable medium 1222 on which is stored the instructions 1224 (e.g., software) embodying any one or more of the methodologies or functions described herein. The instructions 1224 may also reside, completely or at least partially, within the main memory 1204, within the processor 1202 (e.g., within the processor's cache memory), or both, during execution thereof by the machine 1200. Accordingly, the main memory 1204 and the processor 1202 may be considered as machine-readable media. The instructions 1224 may be transmitted or received over a network 1226 (e.g., network 790) via the network interface device 1220.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1222 is shown in an example embodiment to be a single medium, the term “machine-readable medium” should be taken to include a single medium or multiple media (e.g., a centralized or distributed database, or associated caches and servers) able to store instructions (e.g., instructions 1224). The term “machine-readable medium” shall also be taken to include any medium that is capable of storing instructions (e.g., software) for execution by the machine, such that the instructions, when executed by one or more processors of the machine (e.g., processor 1202), cause the machine to perform any one or more of the methodologies described herein. The term “machine-readable medium” shall accordingly be taken to include, but not be limited to, a data repository in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured by software to become a special-purpose processor, the general-purpose processor may be configured as respectively different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing a first search record that corresponds to a first query executed at a first time,
the first search record indicating a first search criterion used in the first query,
the first search record indicating a first number that quantifies a first set of search results returned by the first query;
accessing a second search record that corresponds to a second query executed at a second time subsequent to the first time,
the second search record indicating a second search criterion used in the second query,
the second search record indicating a second number that quantifies a second set of search results returned by the second query;
presenting a first search icon and a second search icon within a graphical layout that indicates the first query as executed prior to the second query,
the first search icon being representative of the first query,
the second search icon being representative of the second query,
the presenting being performed by a module implemented by a processor of a machine.

2. The method of claim 1 further comprising:
presenting a graphical window that includes a portion of the first search record,
the presenting of the graphical window being in response to a cursor event that corresponds to the first search icon within the graphical layout,
the graphical layout including the first search icon and the second search icon.

3. The method of claim 2, wherein:
the presenting of the graphical window includes presenting the first search criterion within the graphical window.

4. The method of claim 2, wherein:
the presenting of the graphical window includes presenting the first number within the graphical window.

5. The method of claim 2, wherein:
the presenting of the graphical window includes presenting the first time within the graphical window.

6. The method of claim 1, wherein:
the presenting of the first search icon and the second search icon within the graphical layout includes presenting the first search icon adjacent to the second search icon.

7. The method of claim 1 further comprising:
presenting the first set of search results returned by the first query,
the presenting of the first set of search results being at a further time subsequent to the second time,
the presenting of the first set of search results being in response to a cursor event that corresponds to the first search icon within the graphical layout,
the graphical layout including the first search icon and the second search icon.

8. The method of claim 1 further comprising:
presenting the second search icon within the graphical layout without the first search icon,
the presenting of the second search icon being in response to a request to delete the first search record,
the request being received from a device of a user.

9. The method of claim 8 further comprising:
determining that the second search record is not dependent on the first search record,
the determining being based on an absence of the first search criterion from the second search record.

10. The method of claim 1 further comprising:
presenting the graphical layout without the first search icon and without the second search icon,
the presenting of the graphical layout being in response to a request to delete the first search record,
the request being received from a device of a user.

11. The method of claim 10 further comprising:
determining that the second search record is dependent on the first search record,
the determining being based on a presence of the first search criterion within the second search record.

12. The method of claim 10 further comprising:
determining that the second search record is dependent on the first search record,
the determining being based on a reference to the first search record within the second search record.

13. The method of claim 1 further comprising:
presenting the second set of search results returned by the second query as a current set of search results returned by a current query,
the presenting of the second set of search results being at a further time subsequent to the second time,
the presenting of the second set of search results being in response to a cursor event that corresponds to the second search icon within the graphical layout,
the graphical layout including the second search icon.

14. The method of claim 13, wherein:
the presenting of the first search icon and the second search icon includes presenting the second search icon as representative of the current query.

15. The method of claim 1 further comprising:
storing a history of searches,
the history of searches including the first search record and the second search record.

16. The method of claim 15, wherein:
the storing of the history of searches is responsive to a request received from a device of a user; and
the history of searches corresponds to the user.

17. The method of claim 15 further comprising:
limiting the history of searches to a maximum quantity of search records,
the maximum quantity being less than a current quantity of search records.

18. The method of claim 17, wherein:
the maximum quantity of search records is a predetermined number; and
the limiting of the history of searches includes
identifying a plurality of recent search records based on a plurality of execution times,
the plurality of recent search records including the first search record and the second search record,
the plurality of execution times including the first time and the second time.

19. A system comprising:
an access module configured to
access a first search record that corresponds to a first query executed at a first time,
the first search record indicating a first search term used in the first query,
the first search record indicating a first number that quantifies a first set of search results returned by the first query; and
access a second search record that corresponds to a second query executed at a second time subsequent to the first time,
the second search record indicating a second search term used in the second query,
the second search record indicating a second number that quantifies a second set of search results returned by the second query; and
a presentation module implemented using a processor of a machine, the presentation module being configured to present a first search icon and a second search icon within a graphical layout that indicates the first query as executed prior to the second query,
the first search icon being representative of the first query,
the second search icon being representative of the second query.

20. A non-transitory machine-readable storage medium comprising instructions that, when executed by one or more processors of a machine, cause the machine to perform operations comprising:
accessing a first search record that corresponds to a first query executed at a first time,
the first search record indicating a first search criterion used in the first query,
the first search record indicating a first number that quantifies a first set of search results returned by the first query;
accessing a second search record that corresponds to a second query executed at a second time subsequent to the first time,
the second search record indicating a second search criterion used in the second query,
the second search record indicating a second number that quantifies a second set of search results returned by the second query;
presenting a first search icon and a second search icon within a graphical layout that indicates the first query as executed prior to the second query,
the first search icon being representative of the first query,
the second search icon being representative of the second query.
